(19) United States
(12) Patent Application Publication
(10) Pub. No.: US 2018/0102058 A1
(43) Pub. Date: Apr. 12, 2018

(54) HIGH-PRECISION AUTONOMOUS OBSTACLE-AVOIDANCE FLYING METHOD FOR UNMANNED AERIAL VEHICLE

(71) Applicant: FEI CAO, BEIJING (CN)

(72) Inventor: FEI CAO, BEIJING (CN)

(21) Appl. No.: 15/839,836

(22) Filed: Dec. 12, 2017

Related U.S. Application Data
(63) Continuation of application No. PCT/CN2015/085497, filed on Jun. 12, 2016.

(30) Foreign Application Priority Data
Jun. 12, 2015 (CN) 201510320701.8

(51) Int. Cl. G08G 5/00; G08G 5/04

(52) U.S. Cl. CPC G08G 5/0069; G08G 5/0039; B64C 2201/141; G08G 5/006; G08G 5/045

(57) ABSTRACT

The present invention relates to a high-precision autonomous obstacle-avoidance flying method for an unmanned aerial vehicle, which includes the following steps: (1) establishing a high-precision map model; (2) planning a three-dimensional flight path and controlling the flight; and (3) transmitting a flight control signal in step (2) to a steering engine of an aircraft servo mechanism of the unmanned aerial vehicle, thereby achieving a control purpose by changing a location of the steering engine.

### CROSS-REFERENCE TO RELATED APPLICATIONS

This application is a continuation of International Patent Application No. PCT/CN2016/085497 with a filing date of Jun. 12, 2016, designating the United States, now pending, and further claims priority to Chinese Patent Application No. 201510320701.8 with a filing date of Jun. 12, 2015. The content of the aforementioned applications, including any intervening amendments thereto, are incorporated herein by reference.

### FIELD OF THE INVENTION

The present invention relates to the field of navigation of unmanned aerial vehicles, and more particularly to a high-precision autonomous obstacle-avoidance flying method for an unmanned aerial vehicle.

### BACKGROUND OF THE INVENTION

An unmanned aerial vehicle is abbreviated as “UAV” and is an unmanned aircraft manipulated by utilizing a radio remote control device and an autonomous program control apparatus. The UAV is widely used in the industries such as police, urban management, agriculture, geology, weather, electric power, disaster relief, video recording, etc. The UAV earns a place in any occasion needing an aerial solution from assisting the modern country to powering smart cities. As the application range of the UAV is wider and wider, a working region is more and more complex, and how to make the autonomous working capability of the UAV higher and higher and to make the UAV more convenient to use is a development trend of a UAV technology.

At present, the UAV has three flight modes, i.e., a manual control flight mode, a semi-automatic piloted flight mode and an automatic piloted flight mode, and for the manual control flight mode and the semi-automatic piloted flight mode, flight control technicians need to operate the UAV in real time to control a flight path. For the automatic piloted flight mode, the flight path is planned before the flight, data is input into a UAV control system and saved, and then the UAV can realize the automatic piloted flight at a predetermined flight path according to satellite positioning.

In low-altitude and complex terrain flight applications, because the existing satellite positioning precision is not enough and the UAV cannot know accurate location information, the full-autonomous flight mode cannot be adopted and the UAV only can be manually operated relying on ground control personnel to fly. In this way, not only long-distance high-precision flight cannot be realized due to the limitation of a communication way, but also the skilled ground control personnel with rich experience is needed, so that the labor cost is high, the operation efficiency is low, and the increasing application demand on the UAV cannot be satisfied.

A traditional UAV cannot realize the high-precision autonomous obstacle avoidance, and can only realize the automatic flight at a high altitude away from obstacles and can only be manipulated by the control personnel with rich experience to assist the flight in a complex flight region close to the obstacles.

### SUMMARY OF THE INVENTION

A purpose of the present invention is to provide a high-precision autonomous obstacle-avoidance flying method for an unmanned aerial vehicle, which enables an unmanned aerial vehicle to have high-precision autonomous flight capability in a complex terrain with respect to defects in the prior art.

In order to achieve the above-mentioned purpose, the present invention discloses a technical solution as follows.

A high-precision autonomous obstacle-avoidance flying method for an unmanned aerial vehicle comprises the following steps:

(1) establishing a high-precision map model:

1.1) after a load operating device of the unmanned aerial vehicle arrives at a designated working region, acquiring, by a differential GPS system, an accurate space location of the unmanned aerial vehicle, and acquiring an accurate space coordinate of a laser scanning system according to a relative location of a known laser scanning system and the unmanned aerial vehicle;

1.2) acquiring, by an inertial navigation apparatus serving as a reference center of a whole laser radar system, a posture and a coordinate location, meeting precision requirements, of the unmanned aerial vehicle;

1.3) collecting data information of a differential GPS and data information of inertial navigation into a storage calculation and control module, and performing the calculation, correction and fusion;

1.4) transmitting the data information in step 1.3 to a laser scanning head rotating at high speed;

1.5) rapidly calculating, by the laser scanning head rotating at the high speed, a space coordinate of each laser point according to distance measurement data and a rotating angle;

1.6) providing the location and posture data of the laser scanning system to the flight control system and a flight path designing system; and

1.7) establishing the high-precision three-dimensional map model;

(2) planning a three-dimensional flight path and controlling the flight:

2.1) accurately planning the flight path on a high-precision three-dimensional map model of a human-computer interaction interface according to the high-precision three-dimensional map model established in the step (1); and

2.2) combining an accurate location signal of the unmanned aerial vehicle and the high-precision three-dimensional map model, and outputting a flight control signal; and

(3) transmitting the flight control signal in the step (2) to a steering engine of an aircraft servo mechanism of the unmanned aerial vehicle, and changing the location of the steering engine so as to achieve a control purpose.

Further, the inertial navigation apparatus is composed of a high-precision three-axis gyroscope and accelerometers in three coordinate axial directions.

Further, the differential GPS system is realized by a micro differential GPS module.

Further, the flight path planning in the step 2.1 is performed in an automatic manner or a manual manner.

Further, a specific step of changing the location of the steering engine in step (3) is as follows: the steering engine of the servo mechanism of the unmanned aerial vehicle is controlled via a pulse width modulation signal, and by utilizing the change of a duty ratio, the location of the steering engine is changed via multiple parallel pulse width modulation signals generated by DSP as well as a signal separately-driven steering engine control circuit.

Further, the three-dimensional map model includes all space coordinates of a destination flight region, and all the space coordinates are saved in a three-dimensional flight control system and are present in a form of a three-dimensional map interface; then the flight path is calculated by utilizing a three-dimensional flight path planning and flight control algorithm; the flight path is saved in the control system of the unmanned aerial vehicle; and when the unmanned aerial vehicle works, the unmanned aerial vehicle accurately acquires the location of the unmanned aerial vehicle through the differential GPS technology in the flight process, and feeds back the location to the three-dimensional flight control system in real time.

Further, the three-dimensional flight control system includes a positioning and navigation module.

Further, the positioning and navigation module is used for completing the following functions:

1) decoding the communication between a computer and the GPS data, including receiving the positioning data, transmitting a GPS control command, and processing the positioning data;

2) calculating a control amount of a track control system, and performing dead-reckoning by utilizing an airborne sensor while the navigation control amount is calculated;

3) performing wind field estimation, and correcting a flight posture by utilizing an estimated wind field so as to reduce the interference of the wind field; and

4) performing, by a navigation calculation module and a data communication system of the flight control computer, high-precision comparison calculation according to the current post-back data and the planned path coordinate, and transmitting a control command to correct the posture and a next flight destination of the unmanned aerial vehicle in time.

The high-precision autonomous obstacle-avoidance flying method for the unmanned aerial vehicle disclosed by the present invention has the following beneficial effects:

By virtue of the micro differential GPS module, the present invention overcomes the disadvantages that an original differential GPS is large in volume and heavy in weight and cannot be loaded on a small-sized aircraft such as the unmanned aerial vehicle and the like, and the volume and the weight of the adopted micro differential GPS module are several tenths of those of the original device; by adopting the differential GPS technology, the positioning precision of the unmanned aerial vehicle can be improved to a centimeter level, so that the unmanned aerial vehicle can acquire own accurate space location in real time during the flight; by adopting the laser scanning technology and combining the differential GPS technology, the space coordinate of a terrain environment of the region can be acquired so as to support the autonomous obstacle-avoidance flight path planning; and a location control error during the whole flight process is controlled at the centimeter level, and the unmanned aerial vehicle is ensured to fly along the pre-planned path, so that an effect of automatically avoiding the obstacle is achieved, and finally the unmanned aerial vehicle can fly to the destination to execute the work.

### BRIEF DESCRIPTION OF THE DRAWINGS

FIG. 1 is a simple flowchart of the present invention; and

FIG. 2 is a detailed flow chart of the present invention.

### DETAILED DESCRIPTION OF THE EMBODIMENTS

The present invention is further described below in combination with embodiments and with reference to the attached drawings.

A high-precision autonomous obstacle-avoidance flying method for an unmanned aerial vehicle includes the following steps:

(1) establishing a high-precision map model:

1.1) after a load operating device of the unmanned aerial vehicle arrives at a designated working region, acquiring, by a differential GPS system, an accurate space location of the unmanned aerial vehicle, and acquiring an accurate space coordinate of a laser scanning system according to a relative location of a known laser scanning system and the unmanned aerial vehicle, wherein the differential GPS system is realized by a micro differential GPS module;

1.2) acquiring, by an inertial navigation apparatus serving as a reference center of a whole laser radar system, a posture, and a coordinate location, meeting the accuracy requirement, of the unmanned aerial vehicle;

1.3) collecting data information of the differential GPS and data information of the inertial navigation into a storage calculation, and control module, and performing the calculation, correction and fusion;

1.4) transmitting the data information in step 1.3 to a laser scanning head rotating at high speed;

1.5) rapidly calculating, by the laser scanning head rotating at the high speed, a space coordinate of each laser point according to distance measurement data and a rotating angle;

1.6) providing the location and posture data of the laser scanning system to the flight control system and a flight path designing system; and

1.7) establishing the high-precision three-dimensional map model;

(2) planning a three-dimensional flight path and controlling the flight:

2.1) accurately planning a flight path on a high-precision three-dimensional map model of a human-computer interaction interface according to the high-precision three-dimensional map model established in the step (1); and

2.2) combining an accurate location signal of the unmanned aerial vehicle and the high-precision three-dimensional map model, and outputting a flight control signal; and

(3) transmitting the flight control signal in step (2) to a steering engine of an aircraft servo mechanism of the unmanned aerial vehicle, and changing the location of the steering engine so as to achieve a control purpose; a specific step of changing the location of the steering engine is as follows: the steering engine of the servo mechanism of the unmanned aerial vehicle is controlled via a pulse width modulation signal, and by utilizing the change of a duty ratio, the location of the steering engine is changed via multiple parallel pulse modulation signals generated by DSP as well as a signal separately-driven steering engine control circuit.

In the present invention, the inertial navigation apparatus is composed of a high-precision three-axis gyroscope and accelerometers in three coordinate axial directions; and the flight path planning in step 2.1 can be performed in an automatic manner or a manual manner.

In the present invention, the three-dimensional map model includes all space coordinates of a destination flight region, and all the space coordinates are saved in a three-dimensional flight control system and are present in a form of a three-dimensional map interface; then a flight path is calculated by utilizing a three-dimensional flight path planning and flight control algorithm, and the flight path is saved in a control system of the unmanned aerial vehicle; and when the unmanned aerial vehicle works, the unmanned aerial vehicle accurately acquires the location of the unmanned aerial vehicle through the differential GPS technology during the flight and feeds back the location to the three-dimensional flight control system in real time.

The three-dimensional flight control system includes a positioning and navigation module, and the positioning and navigation module is used for completing the following functions:

1) decoding the communication between a computer and the GPS data, including receiving the positioning data, transmitting a GPS control command, and processing the positioning data;

2) calculating a control amount of a track control system, and performing dead-reckoning by utilizing an airborne sensor while the navigation control amount is calculated;

3) performing wind field estimation, and correcting a flight posture by utilizing the estimated wind field so as to reduce the interference of the wind field; and

4) performing, by the navigation calculation module and the data communication system of the flight control computer, the high-precision comparison calculation according to the current post-back data and the planned path coordinate, and transmitting a control command to correct the posture and a next flight destination of the unmanned aerial vehicle in time.

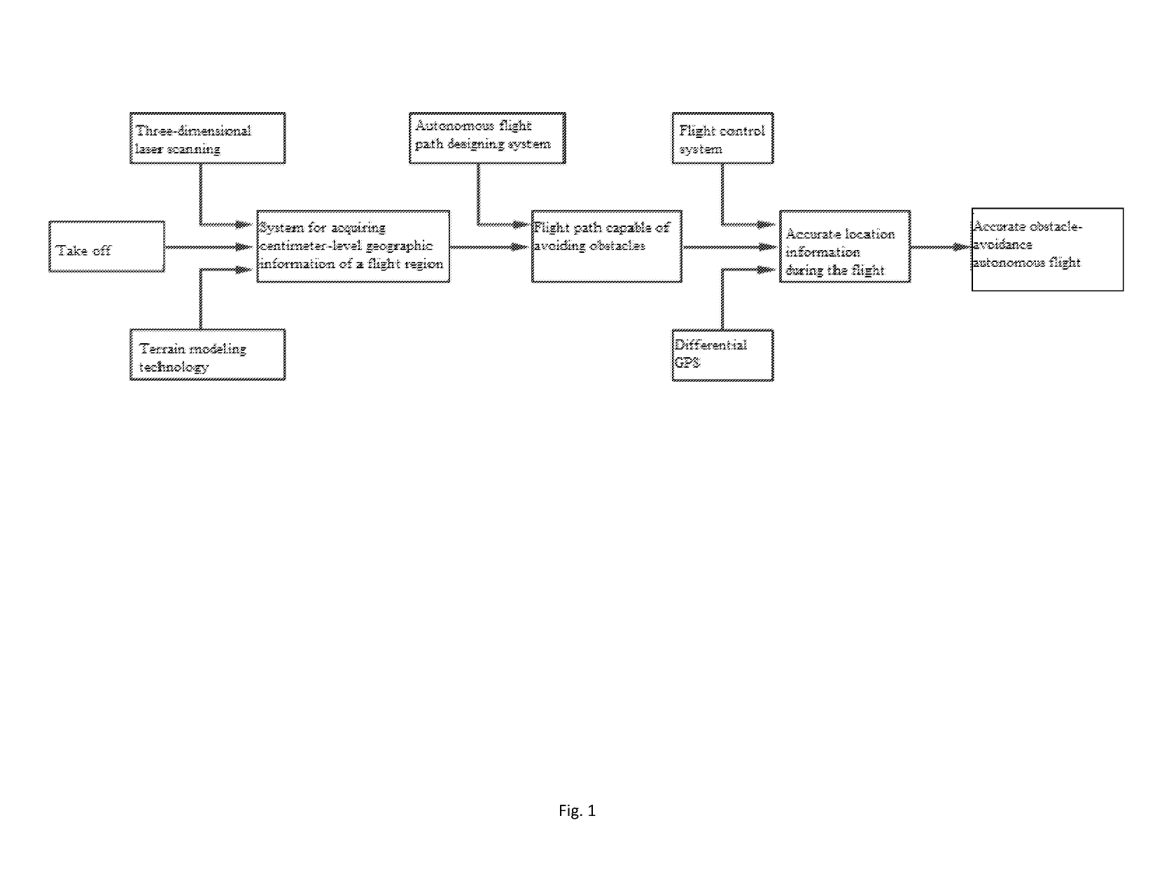

Refer to FIG. 1. After the unmanned aerial vehicle takes off, the centimeter-level geographic information of the flight region is acquired through a three-dimensional laser scanning and terrain modeling technology; and by manually or automatically planning the flight path, the accurate location information during the flight is acquired by utilizing the flight control system and the differential GPS system to perform the accurate obstacle-avoidance autonomous flight.

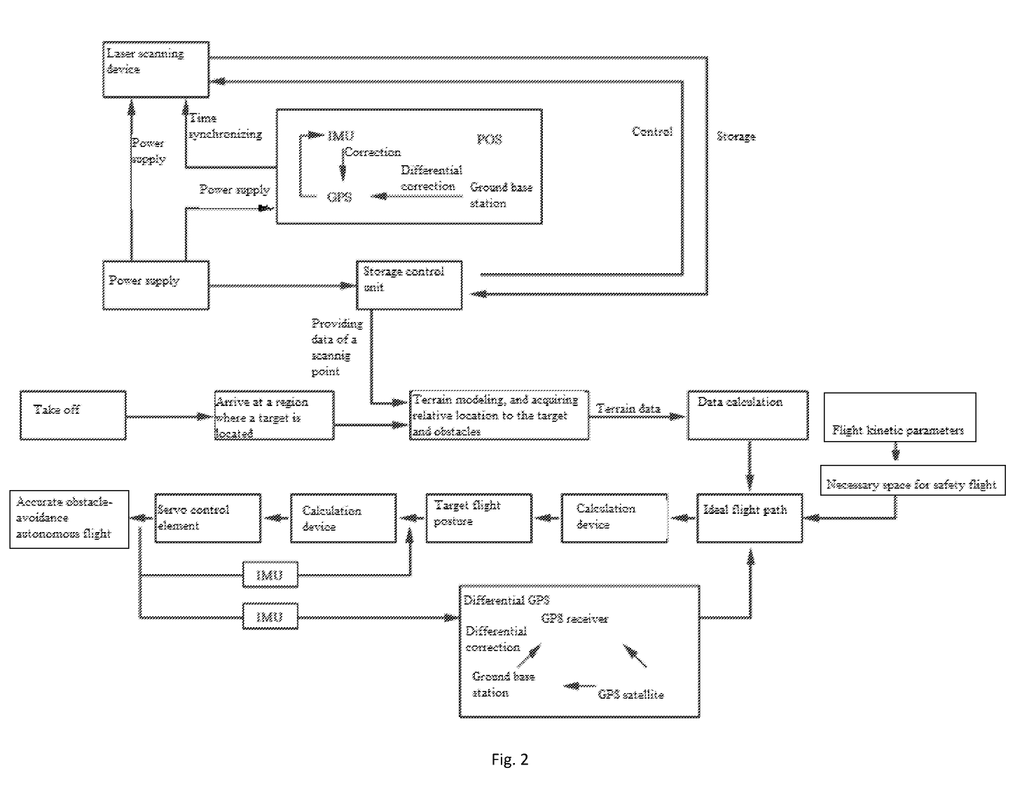

Refer to FIG. 2. When the unmanned aerial vehicle flies to a region where a target is located, the laser scanning device is used for performing the terrain modeling and acquiring the relative location to the target and the obstacle; an ideal flight path is obtained by calculating comprehensive flight kinetic parameters through data; the flight posture of the target is obtained through the calculation device, and the flight control is performed further according to the flight posture; and the real-time correction is performed by utilizing the inertial navigation and differential GPS system. When the terrain modeling is performed, a POS system consisting of the inertial navigation (IMU), the GPS system and the ground base station is synchronized with the laser scanning device; and the laser scanning device saves the data into a storage control unit, and the storage control unit provides the data of a scanning point for performing the terrain modeling.

The present invention realizes the high-precision autonomous obstacle-avoidance flight of the unmanned aerial vehicle and mainly depends on the technologies such as high-precision terrain modeling, the unmanned aerial vehicle accurate positioning and the three-dimensional flight path planning and flight control.

The three main technologies are separately described below:

1. High-Precision Terrain Modeling

A traditional map is two-dimensional and cannot meet the demand of the three-dimensional space flight of the unmanned aerial vehicle. The existing three-dimensional map is generally formulated by adopting a simulation way, and the precision cannot meet the actual flight demand of the unmanned aerial vehicle. By utilizing the latest laser three-dimensional scanning technology, the present invention can rapidly perform the three-dimensional laser scanning for the flight region to establish the centimeter-level three-dimensional geographic information model, so that the flight precision demand of the unmanned aerial vehicle can be completely met.

The posture positioning system (POS system) consists of the differential GPS, the IMU (inertial navigation) and the posture calculation software. An accurate space location of the unmanned aerial vehicle is acquired through the differential GPS system, and an accurate space coordinate of the laser scanning system is acquired according to the relative location of the known laser scanning system and the unmanned aerial vehicle. The IMU consists of the high-precision three-axis gyroscope and the accelerometers in three coordinate axial directions and is also a reference center of the whole laser radar system, and has the advantage that the posture and the coordinate location can be acquired in real time in case of no external reference. The data information of the differential GPS and the data information of the IMU are collected into the storage calculation and control module to perform the calculation correction and fusion, and finally the location and posture data of the laser scanning system is provided for the flight control system and the flight path designing system.

Namely, after the load operating device of the unmanned aerial vehicle arrives at the designated working region, the POS system acquires the location and posture meeting the accuracy requirement and accurately transmits the position and posture to the laser scanning head, and the laser scanning head rotating at high speed can rapidly calculate the space coordinate of each laser point according to the distance measurement data and the rotating angle. Thus, the complex terrain is modeled.

2. Accurate Positioning Technology of the Unmanned Aerial Vehicle

The traditional GPS satellite positioning technology can only realize the positioning precision of 4 to 10 m in a horizontal direction and 10 to 15 m in a vertical direction, which is far from meeting the low-altitude and complex terrain autonomous flight demand of the unmanned aerial vehicle. In the present invention, the unmanned aerial vehicle adopts the differential GPS technology, thereby improving the positioning precision of the unmanned aerial vehicle to the centimeter level, so that the unmanned aerial vehicle can acquire the accurate space location of the unmanned aerial vehicle in real time during the flight. Moreover, the present invention solves the disadvantages that the original differential GPS is large in volume and heavy in weight and cannot be loaded on the small-sized aircraft such as the unmanned aerial vehicle and the like, and the volume and the weight of the adopted micro differential GPS module are several tenths of those of the original device.

3. Three-Dimensional Flight Path Planning and Flight Control Technology

The flight control technology of the unmanned aerial vehicle of the present invention can be based on the high-precision three-dimensional terrain model established above. On the human-computer interaction interface, the flight path can be accurately planned on the high-precision three-dimensional terrain model through a manual or automatic way of the control software, and all space obstacles are avoided; and meanwhile, depending on the accurate flight positioning technology of the unmanned aerial vehicle, the accurate three-dimensional coordinate acquired in real time when the unmanned aerial vehicle flies can be provided for the flight control software, and a flight control software system combines the accurate location signal of the unmanned aerial vehicle and the high-precision three-dimensional terrain model through a more accurate intelligent algorithm to output a flight control signal.

The steering engine of the servo mechanism of the unmanned aerial vehicle is controlled via the PWM (pulse width modulation) signal, and by utilizing the change of the duty ratio, the location of the steering engine is changed via multiple parallel pulse modulation signals generated by the DSP as well as the signal separately-driven steering engine control circuit, thereby achieving a control purpose. The unmanned aerial vehicle is enabled to fly strictly according to the planned flight path, and the precision reaches a centimeter level, thereby achieving an autonomous obstacle-avoidance flight effect.

How to realize the full-autonomous flight of the unmanned aerial vehicle in the complex terrain is described below.

Firstly, the high-precision terrain model is established through the three-dimensional laser scanning technology for the flight region, that is, after the load operating device of the unmanned aerial vehicle arrives at the designated operation region, the POS system acquires the location and posture meeting the accuracy requirement and accurately transmits the position and posture to the laser scanning head, and the laser scanning head rotating at a high speed can rapidly calculate the space coordinate of each laser point according to the distance measurement data and the rotating angle. Thus, the complex terrain is modeled.

The model includes all space coordinates of the destination flight region, and all the space coordinates are saved in a three-dimensional flight control system and are present in a form of a 3D map interface; then a flight path is calculated by utilizing a three-dimensional flight path planning and flight control algorithm; the flight path is saved in the control system of the unmanned aerial vehicle; and when the unmanned aerial vehicle works, the location of the unmanned aerial vehicle acquired accurately by the unmanned aerial vehicle through the differential GPS technology during the flight is fed back to the three-dimensional flight control system in real time.

The positioning and navigation module in the system mainly completes the following functions:

1) decoding the communication between the DSP computer and the GPS data, including: receiving the positioning data, transmitting a GPS control command, and processing the positioning data;

2) calculating, by the navigation DSP computer, the control amount of the track control system;

3) performing the dead-reckoning (DR) by utilizing the airborne sensor while the navigation control amount is calculated;

4) performing wind field estimation (WE) in order to reduce the interference of the wind field, and correcting a flight posture by utilizing the estimated wind field;

5) scheduling a navigation mode, including: planning navigation tasks, and switching various navigation modes; and

6) performing, by the navigation DSP computer and the data communication system of the flight control DSP computer, the high-precision comparison calculation according to the current post-back data and the planned path coordinate of an aircraft, and transmitting a control command to correct the posture and a next flight destination of the unmanned aerial vehicle in time. The location control error of the whole flight process is at a centimeter level, so that the unmanned aerial vehicle is ensured to fly along the pre-planned path, thereby achieving an effect for automatically avoiding the obstacles; and finally the unmanned aerial vehicle flies to the destination to execute the work.

The present invention discloses a high-precision autonomous obstacle-avoidance flying method for an unmanned aerial vehicle. The solution specifically includes: the terrain is accurately modeled by utilizing the three-dimensional laser scanning, the real-time location of the unmanned aerial vehicle during the flight is accurately acquired by utilizing the differential GPS technology, and the three-dimensional flight control system is used for automatically planning the flight path and controlling the flight location of the unmanned aerial vehicle, thereby realizing the autonomous flight of the unmanned aerial vehicle in the complex terrain.

Parameters of the laser scanning device involved in the present invention are as follows:
Measurement range of the gyroscope: ±400°/s
Angular velocity of the gyroscope: 0.15°/√hr
Zero drift of the gyroscope: 0.5°/h
Measurement range of the accelerometer: ±10 g
Measurement deviation of the accelerometer: 0.05 mg
Angular velocity of the accelerometer: 0.06 m/s/√hr
Working voltage: 10 to 30 VDC
Power consumption: 6 W
Dimension: 152.0 mm×141.5 mm×50.5 mm
Weight: 540 g
Working temperature: −40° C. to +65° C.
Storage temperature: −50° C. to +80° C.

The foregoing descriptions are only preferred embodiments of the present invention. It should be noted that for those ordinary skilled in the art, various improvements and supplements can be made to the present invention without departing from the present invention, and these improvements and supplements should be considered as the protection scope of the present invention.

I claim:

1. A high-precision autonomous obstacle-avoidance flying method for an unmanned aerial vehicle, comprising the following steps:
(1) establishing a high-precision map model:
1.1) after a load operating device of the unmanned aerial vehicle arrives at a designated working region, acquiring, by a differential GPS system, an accurate space location of the unmanned aerial vehicle, and acquiring an accurate space coordinate of a laser scanning system according to a relative location of a known laser scanning system and the unmanned aerial vehicle;
1.2) acquiring, by an inertial navigation apparatus serving as a reference center of a whole laser radar system, a posture and a coordinate location, meeting precision requirements, of the unmanned aerial vehicle;
1.3) collecting data information of a differential GPS and data information of inertial navigation into a storage calculation and control module, and performing the calculation, correction and fusion;
1.4) transmitting the data information in step 1.3 to a laser scanning head rotating at high speed;
1.5) rapidly calculating, by the laser scanning head rotating at the high speed, a space coordinate of each laser point according to distance measurement data and a rotating angle;
1.6) providing the location and posture data of the laser scanning system to the flight control system and a flight path designing system; and
1.7) establishing the high-precision three-dimensional map model;
(2) planning a three-dimensional flight path and controlling the flight:
2.1) accurately planning the flight path on a high-precision three-dimensional map model of a human-computer interaction interface according to the high-precision three-dimensional map model established in the step (1); and
2.2) combining an accurate location signal of the unmanned aerial vehicle and the high-precision three-dimensional map model, and outputting a flight control signal; and
(3) transmitting the flight control signal in the step (2) to a steering engine of an aircraft servo mechanism of the unmanned aerial vehicle, and changing the location of the steering engine so as to achieve a control purpose.

2. The high-precision autonomous obstacle-avoidance flying method for the unmanned aerial vehicle according to claim 1, wherein the inertial navigation apparatus is composed of a high-precision three-axis gyroscope and accelerometers in three coordinate axial directions.

3. The high-precision autonomous obstacle-avoidance flying method for the unmanned aerial vehicle according to claim 1, wherein the differential GPS system is realized by a micro differential GPS module.

4. The high-precision autonomous obstacle-avoidance flying method for the unmanned aerial vehicle according to claim 1, wherein the flight path planning in the step 2.1 is performed in an automatic manner or a manual manner.

5. The high-precision autonomous obstacle-avoidance flying method for the unmanned aerial vehicle according to claim 1, wherein a specific step of changing the location of the steering engine in step (3) is as follows: the steering engine of the servo mechanism of the unmanned aerial vehicle is controlled via a pulse width modulation signal, and by utilizing the change of a duty ratio, the location of the steering engine is changed via multiple parallel pulse width modulation signals generated by DSP as well as a signal separately-driven steering engine control circuit.

6. The high-precision autonomous obstacle-avoidance flying method for the unmanned aerial vehicle according to claim 1, wherein the three-dimensional map model includes all space coordinates of a destination flight region, and all the space coordinates are saved in a three-dimensional flight control system and are present in a form of a three-dimensional map interface; then the flight path is calculated by utilizing a three-dimensional flight path planning and flight control algorithm; the flight path is saved in the control system of the unmanned aerial vehicle; and when the unmanned aerial vehicle works, the unmanned aerial vehicle accurately acquires the location of the unmanned aerial vehicle through the differential GPS technology in the flight process, and feeds back the location to the three-dimensional flight control system in real time.

7. The high-precision autonomous obstacle-avoidance flying method for the unmanned aerial vehicle according to claim 6, wherein the three-dimensional flight control system comprises a positioning and navigation module.

8. The high-precision autonomous obstacle-avoidance flying method for the unmanned aerial vehicle according to claim 7, wherein the positioning and navigation module is used for completing the following functions:
1) decoding the communication between a computer and the GPS data, including receiving the positioning data, transmitting a GPS control command, and processing the positioning data;
2) calculating a control amount of a track control system, and performing dead-reckoning by utilizing an airborne sensor while the navigation control amount is calculated;
3) performing wind field estimation, and correcting a flight posture by utilizing an estimated wind field so as to reduce the interference of the wind field; and
4) performing, by a navigation calculation module and a data communication system of the flight control computer, high-precision comparison calculation according to the current post-back data and the planned path coordinate, and transmitting a control command to correct the posture and a next flight destination of the unmanned aerial vehicle in time.
